(19) United States
(12) Patent Application Publication
(10) Pub. No.: US 2023/0067497 A1
(43) Pub. Date: Mar. 2, 2023

(54) FIXING DEVICE AND IMAGE FORMING APPARATUS

(71) Applicant: FUJIFILM Business Innovation Corp., Tokyo (JP)

(72) Inventors: Naoya KAMIGAITO, Kanagawa (JP); Shohei MIYAGAWA, Kanagawa (JP); Mitsuaki KURODA, Kanagawa (JP)

(73) Assignee: FUJIFILM Business Innovation Corp., Tokyo (JP)

(21) Appl. No.: 17/551,932

(22) Filed: Dec. 15, 2021

(30) Foreign Application Priority Data
Aug. 25, 2021 (JP) 2021-137606

(51) Int. Cl. G03G 15/20

(52) U.S. Cl. CPC G03G 15/2028; G03G 15/2025

(57) ABSTRACT

A fixing device includes: a heater that heats an image transferred to a recording medium transported, in a contactless manner; a holding unit that holds the recording medium; and a transport unit that transports the recording medium held by the holding unit along a transport path for the recording medium so that the recording medium is opposed to the heater. The transport path extends in an inclination direction inclined with respect to a horizontal direction as viewed in a width direction of the recording medium transported, and the heater is disposed along the transport path.

### CROSS-REFERENCE TO RELATED APPLICATIONS

This application is based on and claims priority under 35 USC 119 from Japanese Patent Application No. 2021-137606 filed Aug. 25, 2021.

### BACKGROUND

### (i) Technical Field

The present disclosure relates to fixing device and an image forming apparatus.

### (ii) Related Art

Japanese Unexamined Patent Application Publication No. 59-7966 describes a transfer paper transport system in which a recording head having a light emitting device array and an imaging system is moved at a constant speed in a substantially bus direction of a photoconductor drum which rotates at a constant speed, the photoconductor drum is spirally scanned to form a latent image, and a toner image obtained by developing the latent image is transferred to transfer paper.

### SUMMARY

Some fixing devices include a heater that heats a toner image transferred to a recording medium transported, in a contactless manner.

In a fixing device in related art, the transport path for a recording medium extends in a horizontal direction, and a heater heats a toner image in a contactless manner from above the recording medium transported along the transport path. In such a configuration, the heater needs to be disposed along the transport path extending in a horizontal direction, thus the fixing device tends to be large in size.

Aspects of non-limiting embodiments of the present disclosure relate to a fixing device that is configured to reduce increase in device size in a horizontal direction, as compared with other fixing devices including a heater disposed along a transport path extending in a horizontal direction.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a fixing device including: a heater that heats an image transferred to a recording medium transported, in a contactless manner; a holding unit that holds the recording medium; and a transport unit that transports the recording medium held by the holding unit along a transport path for the recording medium so that the recording medium is opposed to the heater, wherein the transport path extends in an inclination direction inclined with respect to a horizontal direction as viewed in a width direction of the recording medium transported, and the heater is disposed along the transport path.

### BRIEF DESCRIPTION OF THE DRAWINGS

Exemplary embodiments of the present disclosure will be described in detail based on the following figures, wherein:

FIG. 1 is a configuration view illustrating a fixing device according to an exemplary embodiment of the present disclosure;

FIG. 2 is a configuration view illustrating the fixing device and a transfer device of an image forming apparatus according to the exemplary embodiment;

FIG. 3 is a perspective view illustrating a principal heater included in the fixing device according to the exemplary embodiment;

FIG. 4 is a perspective view illustrating chains and sprockets included in the fixing device according to the exemplary embodiment;

FIG. 5 is a perspective view illustrating a leading edge holding unit included in the fixing device according to the exemplary embodiment;

FIG. 6 is a plan view illustrating a blowing unit and the leading edge holding unit included in the fixing device according to the exemplary embodiment;

FIG. 7 is a cross-sectional view illustrating the principal heater included in the fixing device according to the exemplary embodiment;

FIG. 8 is an enlarged cross-sectional view illustrating the principal heater included in the fixing device according to the exemplary embodiment;

FIG. 9 is a side view illustrating a cleaner included in the image forming apparatus according to the exemplary embodiment;

FIG. 10 is a side view illustrating a cooler included in the image forming apparatus according to the exemplary embodiment;

FIG. 11 is a configuration view illustrating a toner image former included in the image forming apparatus according to the exemplary embodiment;

FIG. 12 is a schematic configuration view illustrating the image forming apparatus according to the exemplary embodiment; and

FIG. 13 is a configuration view illustrating an image forming apparatus and a fixing device according to a comparative embodiment.

### DETAILED DESCRIPTION

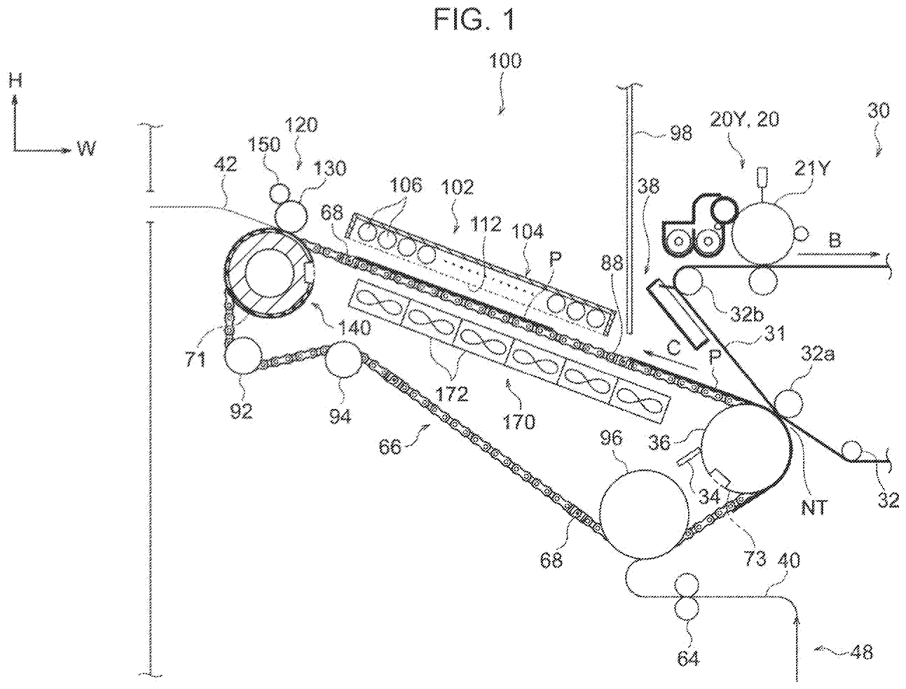

An example of an image forming apparatus according to an exemplary embodiment of the present disclosure will be described with reference to FIGS. 1 to 13. Note that arrow H illustrated in the drawings indicates a device up-down direction (vertical direction), arrow W indicates a device width direction (horizontal direction), and arrow D indicates a device depth direction (horizontal direction).

### Image Forming Apparatus 10

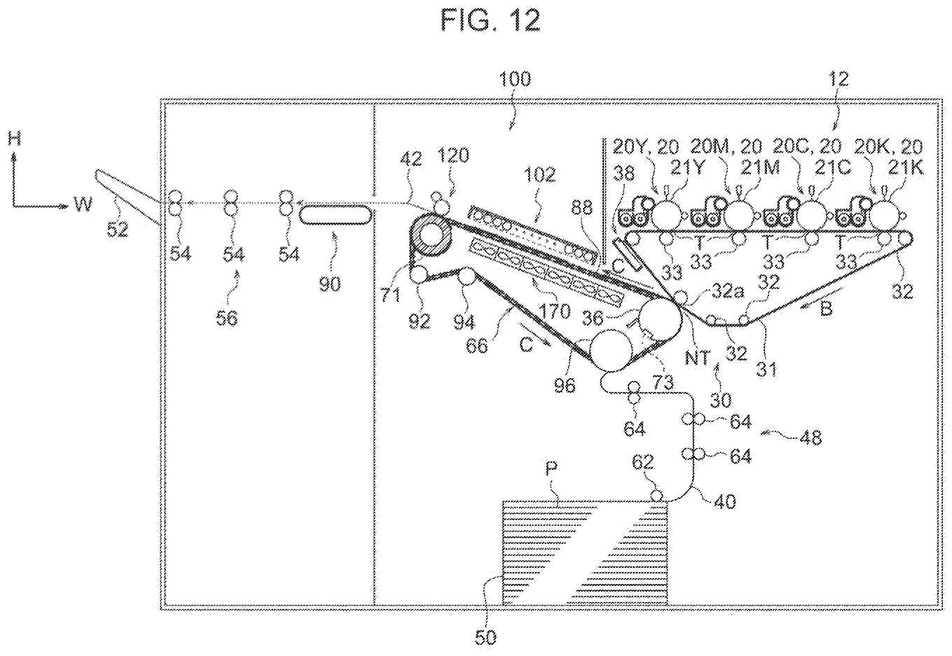

An image forming apparatus 10 according to the exemplary embodiment is an electrophotographic image forming apparatus that forms a toner image on a sheet member P as a recording medium. As illustrated in FIG. 12, the image forming apparatus 10 includes a storage section 50, a paper feed mechanism 48, an image former 12, a fixing device 100, a cooler 90, a paper discharge mechanism 56, and a discharge section 52.

### Storage Section 50

The storage section 50 has a function of storing sheet members P.

### Paper Feed Mechanism 48

The paper feed mechanism 48 has a function of transporting sheet member P stored in the storage section 50 to a chain gripper 66 which is as an example of a leading edge holding unit included in the fixing device 100.

Specifically, as illustrated in FIG. 12, the paper feed mechanism 48 includes a delivery roll 62, and multiple transport rolls 64 for transporting the sheet member P along a paper feed path 40 along which the sheet member P is transported.

The delivery roll 62 is a roll for delivering the sheet member P stored in the storage section 50 to the paper feed path 40. The multiple transport rolls 64 are rolls for transporting sheet member P to the chain gripper 66, the sheet member P being delivered to the paper feed path 40 by the delivery roll 62.

### Image Former 12

The image former 12 has a function of forming an image on the sheet member P by an electrophotographic method. The image former 12 includes a toner image former 20 that forms a toner image, and a transfer device 30 that transfers the toner image formed by the toner image former 20 to the sheet member P.

### Toner Image Former 20

Multiple toner image formers 20 are provided to form a toner image for each color. The image former 12 includes toner image formers 20Y, 20M, 20C, 20K for a total of four colors: yellow (Y), magenta (M), cyan (C), and black (K). (Y), (M), (C), (K) illustrated in FIG. 12 indicate respective component sections corresponding to the colors. Note that when the colors are not particularly distinguished, the last letter of each symbol is omitted.

The toner image formers 20Y, 20M, 20C, 20K are basically configurated in the same manner except for the toner to be used.

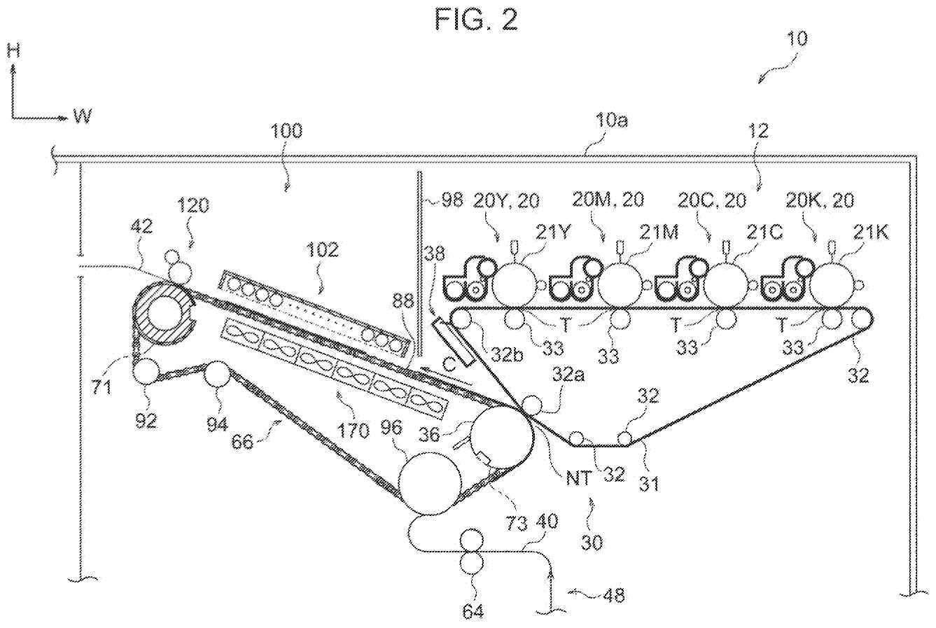

As illustrated in FIG. 2, the toner image formers 20 are arranged side by side on a horizontal part of a transfer belt 31 provided in the transfer device 30.

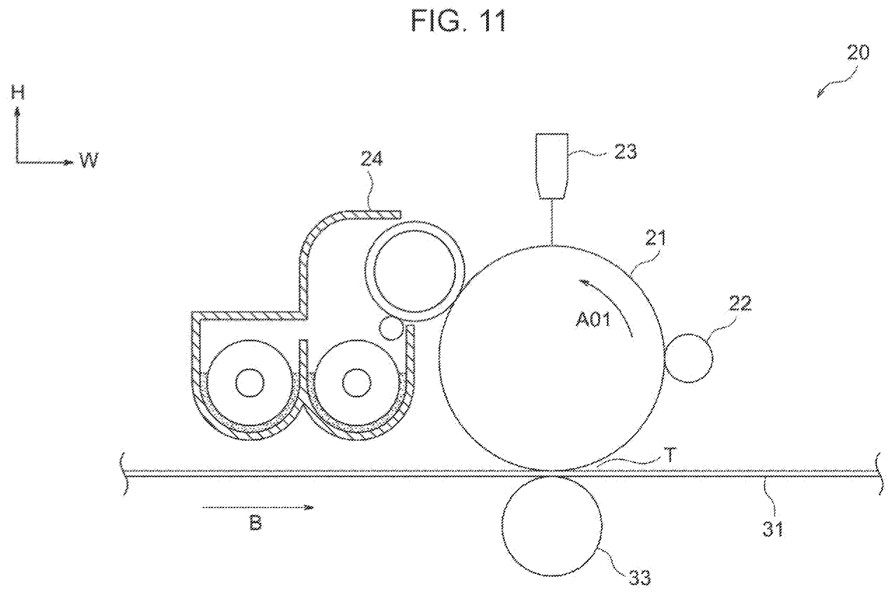

As illustrated in FIG. 11, each toner image former 20 includes a photoconductor drum 21 (=photoconductor) that rotates in arrow A01 direction in FIG. 11, and a charger 22 that charges the photoconductor drum 21. In addition, the toner image former 20 includes an exposure device 23 that forms an electrostatic latent image by exposing the photoconductor drum 21 charged by the charger 22, and a developing device 24 that forms a toner image by developing the electrostatic latent image using toner.

### Transfer Device 30

The transfer device 30 has functions of superimposing and first transferring a toner image on the photoconductor drum 21 of each color to an intermediate transfer body, and second transferring the superimposed toner image to the sheet member P. Specifically, as illustrated in FIG. 2, the transfer device 30 includes a transfer belt 31 as an intermediate transfer body, multiple rolls 32, first transfer rolls 33, a second transfer roll 36, and a remover 38. The second transfer roll 36 is an example of a transfer unit. Note that the details of the remover 38 will be described below.

The transfer belt 31 has an endless form, and is wound over the multiple rolls 32 in a posture of an inverted triangular shape. The transfer belt 31 is circumferentially rotated by at least one of the multiple rolls 32 being rotationally driven in arrow B direction.

In the following description, of the multiple rolls 32, a roll 32 disposed so as to push an inclined section is referred to as a roll 32a, the inclined section being on one side (the left side of FIG. 2) of the transfer belt 31 in the device width direction. A roll over which a section on one side of the transfer belt 31 in the device width direction is wound is referred to as a roll 32b.

The first transfer rolls 33 are disposed on the opposite side of the transfer belt 31 from the photoconductor drum 21 of each color. The first transfer rolls 33 each have a function of transferring a toner image formed on the photoconductor drum 21 to the transfer belt 31 at a first transfer position T (see FIG. 11) between the photoconductor drum 21 and the first transfer roll 33.

The second transfer roll 36 is disposed on the opposite side of the transfer belt 31 from the roll 32a. The second transfer roll 36 has a function of transferring a toner image transferred to the transfer belt 31 onto the sheet member P at a second transfer position NT between the transfer belt 31 and the second transfer roll 36. The second transfer position NT is an example of a transfer position.

### Fixing Device 100

The fixing device 100 has a function of fixing a toner image on the sheet member P, the toner image being transferred to the sheet member P by the transfer device 30.

As illustrated in FIG. 2, the fixing device 100 includes the chain gripper 66 for transporting the sheet member P, a pre heater 102 that heats the sheet member P, a principal heater 120 that heats the sheet member P, and a blowing unit 170 that blows air to the sheet member P. Note that the details of the fixing device 100 will be described below.

### Cooler 90

The cooler 90 has a function of cooling the sheet member P heated by the fixing device 100. As illustrated in FIG. 12, a paper discharge path 42 is formed along which sheet member P is transported which is to receive a toner image fixed by the fixing device 100 and to be discharged to the outside of a device body 10a. The cooler 90 is disposed along the paper discharge path 42.

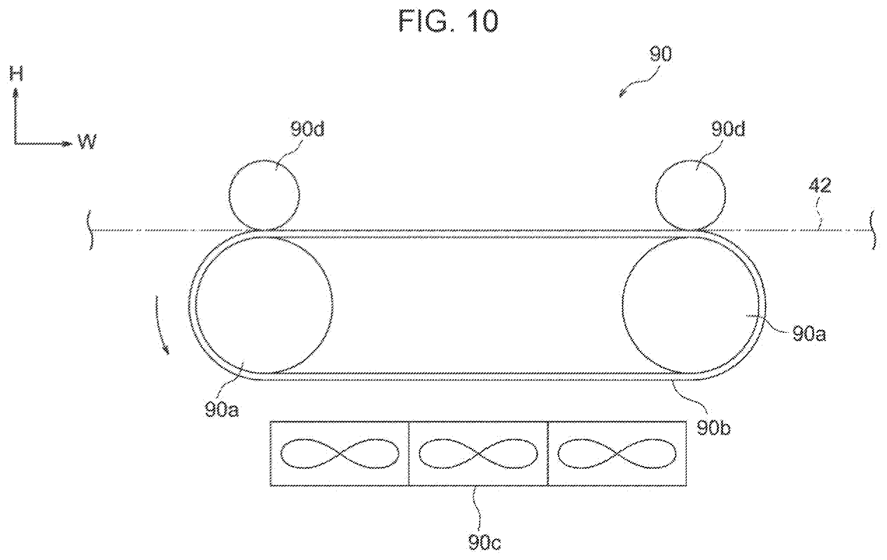

As illustrated in FIG. 10, the cooler 90 includes two rolls 90a arranged side by side in the device width direction, and an endless-formed belt 90b wound over the two rolls 90a, the endless-formed belt 90b having an upper surface along the paper discharge path 42. In addition, the cooler 90 includes a cooling fan 90c that cools the belt 90b by blowing air to the lower surface of the belt 90b, and rolls 90d disposed on the opposite side of the paper discharge path 42 and the belt 90b from the two rolls 90a.

In this configuration, either one of the two rolls 90a rotates due to a rotational force transmitted thereto from a driving member which is not illustrated. Thus, the belt 90b cooled by the cooling fan 90c circumferentially rotates in the arrow direction in FIG. 10, thus the rolls 90d are driven to rotate by the circumferentially rotating belt 90b. Furthermore, the circumferentially rotating belt 90b and the rotating rolls 90d transport the sheet member P with interposed therebetween.

### Paper Discharge Mechanism 56

The paper discharge mechanism 56 has a function of discharging the sheet member P cooled by the cooler 90 to the discharge section 52 outside the device body 10a. As illustrated in FIG. 12, the paper discharge mechanism 56 is disposed on one side (the left side of FIG. 12) of the image former 12 in the device width direction.

The paper discharge mechanism 56 includes multiple transport rolls 54 for transporting the sheet member P along the paper discharge path 42.

### Operation of Image Forming Apparatus

In the image forming apparatus 10 illustrated in FIG. 12, a toner image is formed on the sheet member P in the following manner. First, the charger 22 for each color illustrated in FIG. 11 negatively charges the surface of the photoconductor drum 21 of the color uniformly at a predetermined potential. Subsequently, the exposure device 23 radiates exposure light to the charged surface of the photoconductor drum 21 of the color to form an electrostatic latent image based on image data input from the outside.

Thus, an electrostatic latent image corresponding to the image data is formed on the surface of each photoconductor drum 21. Furthermore, the developing device 24 of each color develops the electrostatic latent image, and visualizes the latent image as a toner image. Each first transfer roll 33 of the transfer device 30 illustrated in FIG. 2 transfers the toner image formed on the surface of the photoconductor drum 21 of the color to the transfer belt 31 at the first transfer position T.

Thus, the sheet member P is delivered by the delivery roll 62 from the storage section 50 illustrated in FIG. 12 to the paper feed path 40, then the sheet member P is transported by the transport rolls 64, received by the chain gripper 66, and transported by the chain gripper 66. The sheet member P transported by the chain gripper 66 is delivered to the second transfer position NT where contact is made between the transfer belt 31 and the second transfer roll 36 along the paper feed path 40, a partial transport path up to the second transfer position NT, along which the sheet member P is transported by the chain gripper 66, and a turn back shaped transport path formed by a downstream transport path after the second transfer position NT. At the second transfer position NT, the sheet member P is interposed and transported between the transfer belt 31 and the second transfer roll 36, thus the toner image on the surface of the transfer belt 31 is transferred to the surface of the sheet member P.

Furthermore, the toner image transferred to the surface of the sheet member P is fixed on the sheet member P by the fixing device 100, and the sheet member P is delivered to the paper discharge path 42 illustrated in FIG. 12. The sheet member P delivered to the paper discharge path 42 is cooled by being transported through the cooler 90, and transported by the transport rolls 54. The sheet member P is then discharged to the discharge section 52 outside the device body 10a.

### Principal Component Configuration

Next, the fixing device 100, and the remover 38 of the transfer device 30 will be described.

### Fixing Device 100

As illustrated in FIG. 1, the fixing device 100 includes the chain gripper 66, the pre heater 102 that heats a toner image transferred to the sheet member P in a contactless manner, the principal heater 120 that comes into contact with the sheet member P to heat the toner image, and the blowing unit 170. The pre heater 102 is an example of a heater, and the principal heater 120 is an example of a contact heater.

### Chain Gripper 66

The chain gripper 66 includes a pair of chains 72, a leading edge holding unit 68 that holds the leading edge of the sheet member P, and sprockets 71, 73, 92, 94, 96. The chains 72 are an example of a circumferential rotation unit.

### Chain 72, Sprockets 71, 73, 92, 94, 96

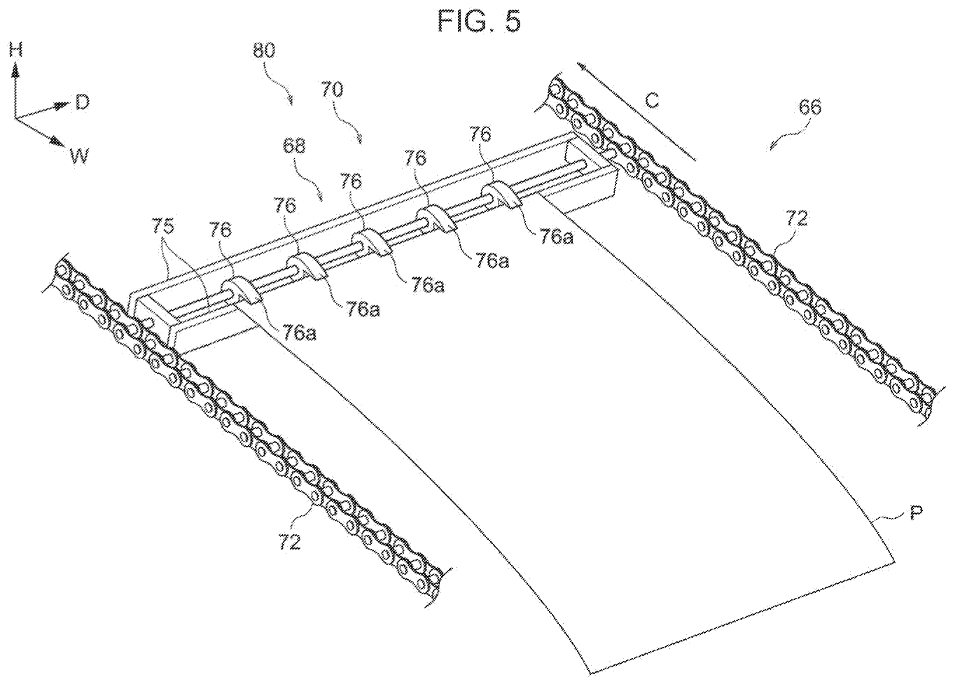

The pair of chains 72 are formed in an endless form, and are disposed apart in the device depth direction as illustrated in FIG. 5. In the present exemplary embodiment, the device depth direction is the same as the width direction of the transported sheet member P.

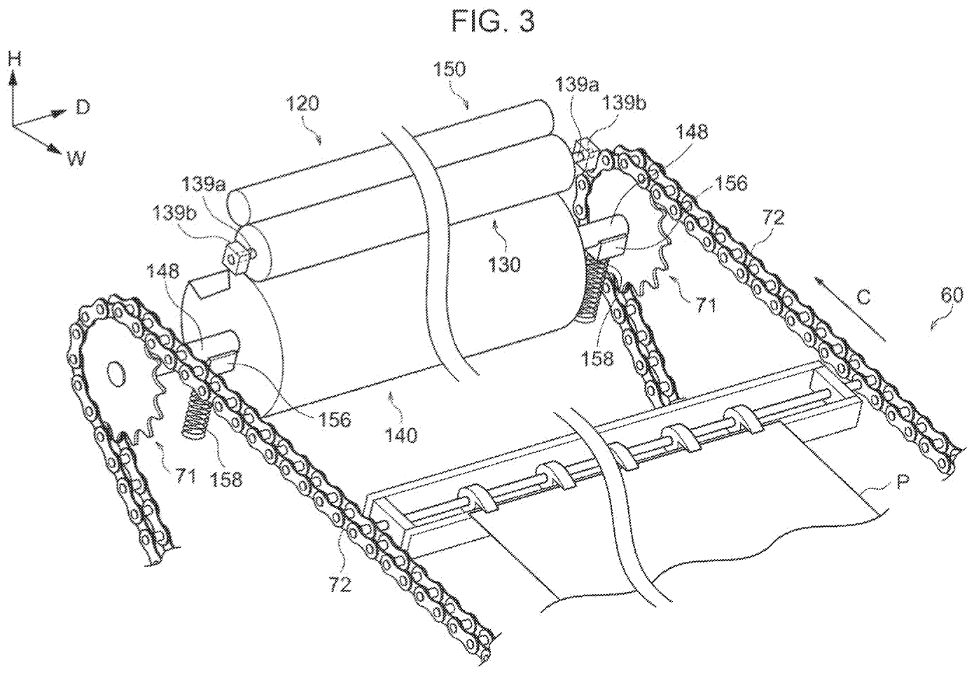

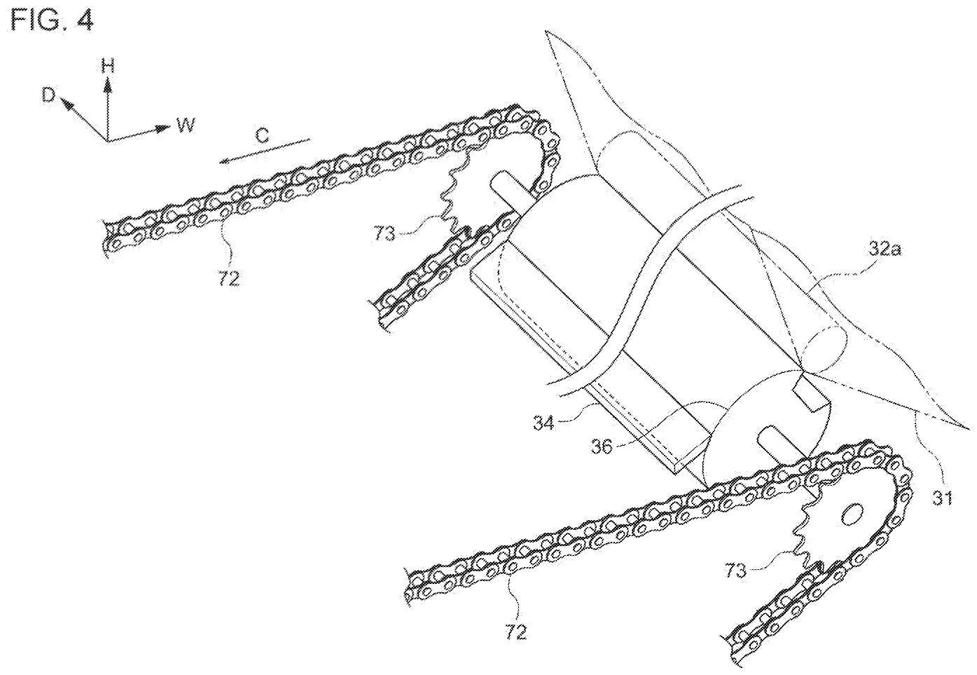

As illustrated in FIG. 1, the pair of chains 72 are disposed at one end and the other end of the second transfer roll 36 in an axial direction, and are wound over a pair of sprockets 73 (see FIG. 4) with the axial direction in the device depth direction. The pair of chains 72 are disposed at one end and the other end of the later-described pressure roll 140 in an axial direction, and are wound over a pair of sprockets 71 (see FIG. 3) with the axial direction in the device depth direction. Furthermore, the pair of chains 72 are wound over a pair of sprockets 92, a pair of sprockets 94, and a pair of sprockets 96 which are disposed at intervals in the device depth direction. Although the pair of chains 72, the pair of chains 73, the pair of sprockets 92, the pair of sprockets 94, and the pair of sprockets 96 are provided in the present exemplary embodiment, the chains or sprockets are not necessarily provided as a pair, and a chain or a sprocket disposed only on one side may be provided.

The sprockets 71 (see FIG. 3) disposed on both ends of the pressure roll 140, and the sprockets 71 (see FIG. 4) disposed on both ends of the second transfer roll 36 are adjacent to each other. As viewed in the device depth direction, the sprockets 71 are disposed on one side (the left side of FIG. 2) and on an upper side of the sprockets 73 in the device width direction. In other words, the part of the chains 72 between a chain section wound over the sprocket 73 and a chain section wound over the sprocket 71 is inclined with respect to a horizontal direction.

As viewed in the device depth direction, the pair of sprockets 92 are disposed on the lower side of the sprockets 71. In addition, the pair of sprockets 96 are disposed on the lower side of the sprockets 73, 92, and on one side of the sprockets 73 in the device width direction, and on the other side of the sprockets 92 in the device width direction. The pair of sprockets 94 are disposed so as to raise the part of the chains 72 between the sprockets 92 and the sprockets 96 from the lower side to the upper side. In addition, a transport roll (not illustrated) is disposed between the pair of sprockets 96, the transport roll being coaxial with the pair of sprockets 96.

In this configuration, a rotational force is transmitted to one of the multiple sprockets 71, 73, 92, 94, 96, thus the pair of chains 72 circumferentially rotate in arrow C direction of FIG. 2 so as to move from the sprockets 73 to the sprockets 71. Note that the rotational force is to be transmitted to the sprockets 73 in the present exemplary embodiment.

### Leading Edge Holding Unit 68

As illustrated in FIG. 5, the leading edge holding unit 68 includes mounting members 75 extending in the device depth direction, and grippers 76 mounted on the mounting members 75. The sections on both sides of the leading edge holding unit 68 in the device depth direction are mounted on the pair of chains 72, respectively.

Multiple edge holding units 68 are provided, and disposed in the circumferential direction (circumferential rotation direction) of the chains 72 at predetermined intervals (see FIG. 1).

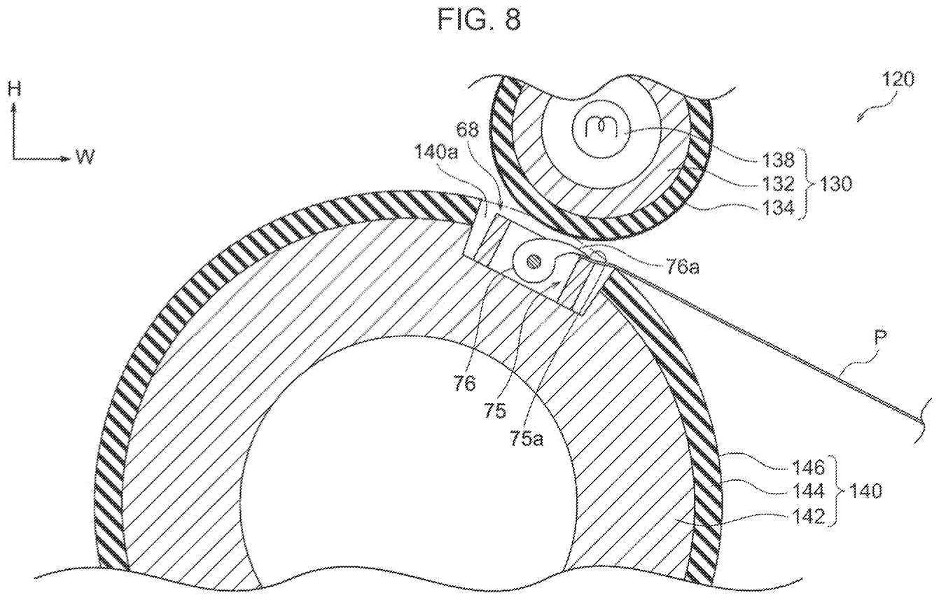

Multiple grippers 76 are provided, and mounted on the mounting members 75 at predetermined intervals in the device depth direction. The grippers 76 have a function of holding the leading edge of each sheet member P. Specifically, each gripper 76 has a nail 76a. In addition, each mounting member 75 has a contact section 75a (see FIG. 8) with which the nail 76a is to come into contact.

The gripper 76 is configured to hold the sheet member P by gripping the leading edge of the sheet member P between the nail 76a and the contact section 75a. In each gripper 76, for example, the nail 76a is pressed against the contact section 75a by a spring or the like, as well as the nail 76a is brought into contact with or separated from the contact section 75a by an operation of a cam or the like. In this manner, a holding unit 70 to hold the sheet member P is formed by the leading edge holding unit 68.

In this configuration, in the chain gripper 66 illustrated in FIG. 1, when the leading edge holding unit 68 arrives at the lower end position of the sprockets 96, the grippers 76 of the leading edge holding unit 68 grip the leading edge of the sheet member P transported by the transport rolls 64 along the paper feed path 40, thus hold and receive the sheet member P. The chains 72, which circumferentially rotate in the arrow C direction, transport the sheet member P held by the leading edge holding unit 68 to the second transfer position NT. In addition, the circumferentially rotating chains 72 transport the sheet member P so that it is opposed to the pre heater 102, then transports the sheet member P to the principal heater 120. After the sheet member P passes through the principal heater 120, the leading edge holding unit 68 releases edge holding of the sheet member P, and the chain gripper 66 delivers the sheet member P to the paper discharge path 42.

In this manner, a transport unit 80 is formed which includes a transport path 88 for transporting the sheet member P held by the leading edge holding unit 68 using the pair of chains 72.

### Pre Heater 102

As illustrated in FIG. 1, in the transport direction of the sheet member P (hereinafter referred to as the “sheet transport direction”), the pre heater 102 is disposed downstream of the second transfer position NT where a toner image is transferred to the sheet member P, and opposed to the sheet member P transported between the sprockets 73 and the sprockets 71. Specifically, the pre heater 102 is disposed to be opposed to the upper surface side (=the side on which a toner image is transferred) of the transported sheet member P.

As described above, the part of the chains 72 between the chain section wound over the sprocket 73 and the chain section wound over the sprocket 71 is inclined with respect to a horizontal direction. Therefore, the transport path 88 for the sheet member P transported between the sprockets 73 and the sprockets 71 extends in an inclination direction inclined with respect to the horizontal direction. In other words, the transport path 88 for the sheet member P from the second transfer position NT to the principal heater 120 extends in an inclination direction inclined with respect to the horizontal direction. Specifically, between the second transfer position NT and the principal heater 120, the transport path 88 extends so that downstream part of the chains 72 is on the upper side of upstream part of the chains 72 in the sheet transport direction.

In this manner, the pre heater 102 opposed to the sheet member P transported in the inclination direction is disposed along the transport path 88 which extends in the inclination direction.

In addition, as illustrated in FIG. 2, the pre heater 102 is apart in the device width direction (horizontal direction) from the image former 12 that forms a toner image and transfers the toner image to the sheet member P. Furthermore, the second transfer position NT where the toner image is transferred to the sheet member P by the second transfer roll 36 is on the lower side of the position where the sheet member P is heated by the pre heater 102. Here, “the position where the sheet member P is heated by the pre heater 102” is the position where the transported sheet member P is opposed to the pre heater 102 as viewed in the device depth direction.

As illustrated in FIG. 1, the pre heater 102 includes a reflection member 104, multiple infrared heaters 106 (hereinafter referred to as a “heater 106”), and a wire mesh 112.

### Reflection Member 104

The reflection member 104 is formed using an aluminum plate, and has a box shape with a shallow bottom, having an open side facing the transported sheet member P. In other words, the reflection member 104 has a U shape with an open side facing the transported sheet member P as viewed in the device width direction. In the present exemplary embodiment, as viewed in a thickness direction of the transported sheet member P, the reflection member 104 covers the sheet member P in the width direction of the transported sheet member P as well as in the sheet transport direction. The heater 106 is disposed inside the reflection member 104.

### Heater 106

The heater 106 is an infrared heater having a cylindrical external shape, and extends in the device depth direction. Multiple heaters 106 are provided, and arranged side by side in the sheet transport direction. In this configuration, upon application of a voltage from a power supply (not illustrated), the heaters 106 emit infrared rays with the highest spectral radiance.

### Wire Mesh 112

The wire mesh 112 is fixed to the rim of the reflection member 104 by a fixing member which is not illustrated, and divides the inside of the reflection member 104 and the outside of the reflection member 104. Thus, the wire mesh 112 prevents the transported sheet member P and the heaters 106 from coming into contact with each other.

In this configuration, the pre heater 102 heats the sheet member P transported by the circumferentially rotating chains 72 in the thickness direction of the sheet member P in a contactless manner. Heating the sheet member P causes the toner in the toner image transferred to the sheet member P to be softened. In this manner, the pre heater 102 functions as a contactless heating unit to heat the toner in a contactless manner without pressurizing the toner to the sheet member P.

### Blowing Unit 170

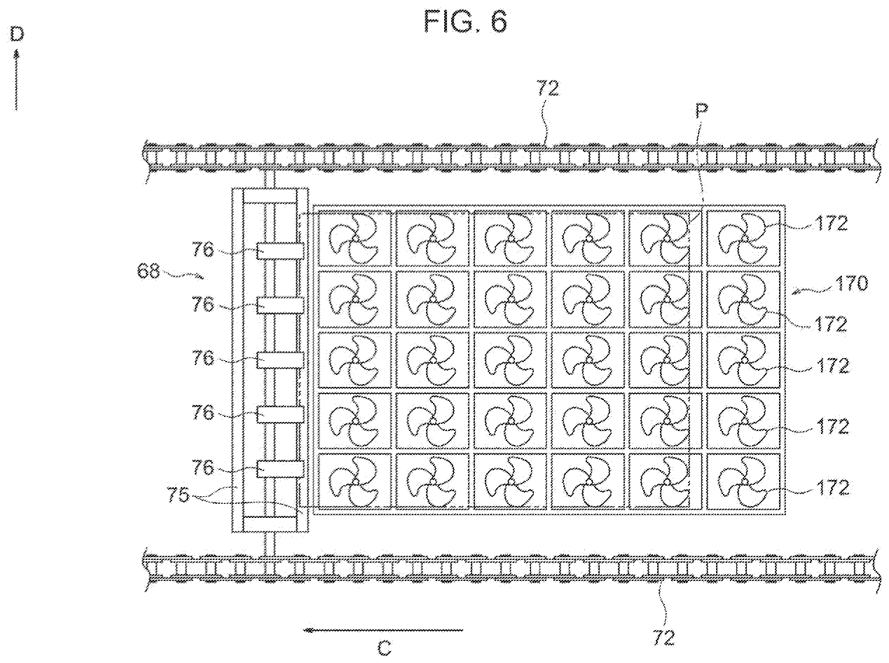

As illustrated in FIG. 1, the blowing unit 170 is disposed to be opposed to the pre heater 102 in the thickness direction of the transported sheet member P, and the transported sheet member P is designed to pass between the blowing unit 170 and the pre heater 102. As illustrated in FIG. 6, the blowing unit 170 includes multiple fans 172 arranged side by side in the width direction of the transported sheet member P and in the sheet transport direction.

In this configuration, the multiple fans 172 blow air to the transported sheet member P, thus the transport posture of the transported sheet member P is stabilized. In this manner, the fans 172 each function as a posture stabilizing unit to stabilize the transport posture of the transported sheet member P.

### Principal Heater 120

As illustrated in FIG. 1, the principal heater 120 is disposed downstream of the pre heater 102 in the sheet transport direction. Thus, the position where the sheet member P is heated by the principal heater 120 is on the upper side of the position where the recording medium is heated by the pre heater 102. Here, “the position where the sheet member P is heated by the principal heater 120” is the position where the later-described heating roll 130 and the pressure roll 140 are in contact with each other.

As illustrated in FIG. 2, the principal heater 120 is apart in the device width direction (horizontal direction) from the image former 12 that forms a toner image and transfers the toner image to the sheet member P. In addition, as illustrated in FIG. 3, the principal heater 120 includes a heating roll 130 that comes into contact with the transported sheet member P to heat the sheet member P, the pressure roll 140 that pressurizes the sheet member P against the heating roll 130, and a driven roll 150 that is driven to rotate by the heating roll 130.

### Heating Roll 130

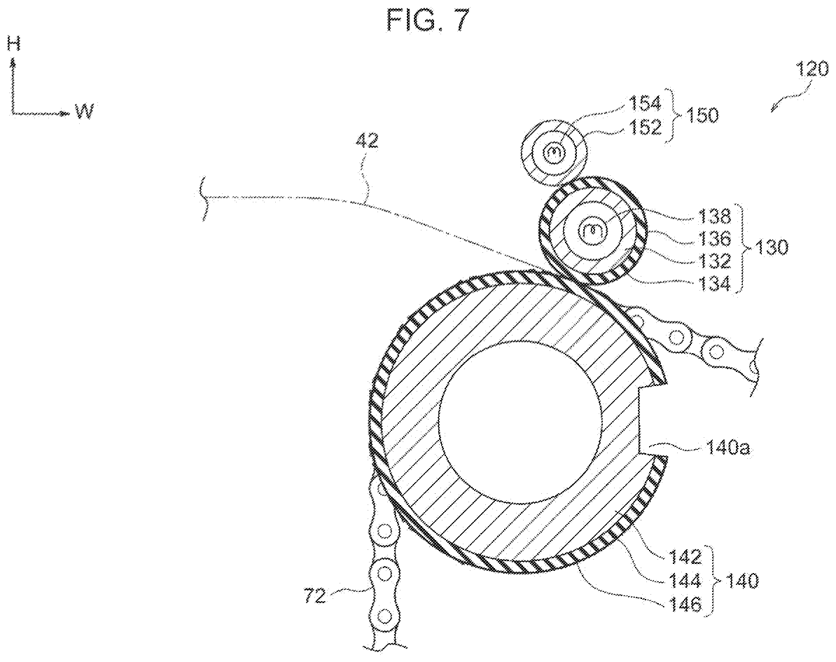

As illustrated in FIG. 3, the heating roll 130 comes into contact with the upward surface of the transported sheet member P, and is disposed to extend in the device depth direction which is the axial direction. As illustrated in FIG. 7, the heating roll 130 has a cylindrical base material 132, a rubber layer 134 formed to cover the entire circumference of the base material 132, a release layer 136 formed to cover the entire circumference of the rubber layer 134, and a heater 138 stored inside the base material 132.

The base material 132 is, for example, a circular tube-shaped metal member, such as an aluminum tube. The rubber layer 134 is made of, for example, silicone rubber. In addition, the release layer 136 is made of copolymer (PFA resin) of tetrafluoroethylene and perfluoro ethylene, for example.

As illustrated in FIG. 3, shafts 139a extending in the device depth direction are respectively formed at both ends of the heating roll 130 in the device depth direction, and support members 139b are provided which respectively support the shafts 139a. Thus, the heating roll 130 is rotatably supported by the support members 139b at both ends of the heating roll 130.

### Driven Roll 150

As illustrated in FIG. 3, the driven roll 150 is disposed to extend in the device depth direction which is the axial direction on the opposite side of the heating roll 130 from the transported sheet member P. As illustrated in FIG. 7, the driven roll 150 has a cylindrical base material 152, and a heater 154 stored inside the base material 152.

The base material 152 is, for example, a circular tube-shaped metal member, such as an aluminum tube. The driven roll 150 is rotatably supported by support members (not illustrated) at both ends of the driven roll 150.

In this configuration, the driven roll 150 is driven to rotate by the heating roll 130. The driven roll 150 then heats the heating roll 130. Specifically, the driven roll 150 is configured to heat the heating roll 130 so that the surface temperature of the heating roll 130 reaches a predetermined temperature along with the driven rotation using a heater built in the driven roll 150.

### Pressure Roll 140

As illustrated in FIG. 3, the pressure roll 140 is disposed to come into contact with the downward surface of the transported sheet member P, on the opposite side of the transported sheet member P from the heating roll 130, and to extend in the device depth direction which is the axial direction. As illustrated in FIG. 7, the pressure roll 140 includes a cylindrical base material 142, a rubber layer 144 formed to cover the base material 142, a release layer 146 formed to cover the rubber layer 144, and a pair of shafts 148 (see FIG. 3) formed at both ends in the device depth direction. The outer diameter of the outer circumferential surface of the release layer 146 in the pressure roll 140 is made greater than the outer diameter of the heating roll 130.

The base material 142 is, for example, a circular tube-shaped metal member, such as an aluminum tube. The rubber layer 144 is made of, for example, silicone rubber. The release layer 146 is made of copolymer (PFA resin) of tetrafluoroethylene and perfluoro ethylene, for example.

As illustrated in FIG. 8, a recess 140a is formed in the outer circumferential surface of the pressure roll 140, the recess 140a extending in the device depth direction. When the sheet member P passes between the pressure roll 140 and the heating roll 130, the leading edge holding unit 68 gripping the leading edge of the sheet member P is designed to be stored in the recess 140a.

As illustrated in FIG. 3, the pair of shafts 148 are formed at both ends in the device depth direction, and smaller in diameter than the pressure roll 140, and extend in the axial direction.

### Others

As illustrated in FIG. 3, the principal heater 120 includes support members 156 that support the pressure roll 140, and urging members 158 that urge the pressure roll 140 against the heating roll 130 via the support members 156. A pair of support members 156 are provided. The pair of support members 156 are respectively disposed so as to rotatably support the pair of shafts 148 of the pressure roll 140 from below.

The urging members 158 are compression springs provided as a pair, and disposed on the opposite side of the support members 156 from the shafts 148.

In this configuration, the pair of urging members 158 urge the pressure roll 140 against the heating roll 130, thus the pressure roll 140 pressurizes the sheet member P to the heating roll 130. In addition, the pressure roll 140 rotates due to a rotational force transmitted thereto from a drive member (not illustrated). The heating roll 130 is driven to rotate by the pressure roll 140 in rotation, and the driven roll 150 is driven to rotate by the heating roll 130 in rotation. In addition, the sheet member P with a transferred toner image is interposed and transported between the heating roll 130 and the pressure roll 140, thus the toner image is heated and fixed on the sheet member P.

### Remover 38 of Transfer Device 30

As illustrated in FIG. 2, the remover 38 is disposed on the opposite side of the transfer belt 31 from the roll 32b and apart from the principal heater 120 and the pre heater 102 in the device width direction (horizontal direction). In addition, the remover 38 is disposed on the lower side of the upper end of the pre heater 102 in the up-down direction.

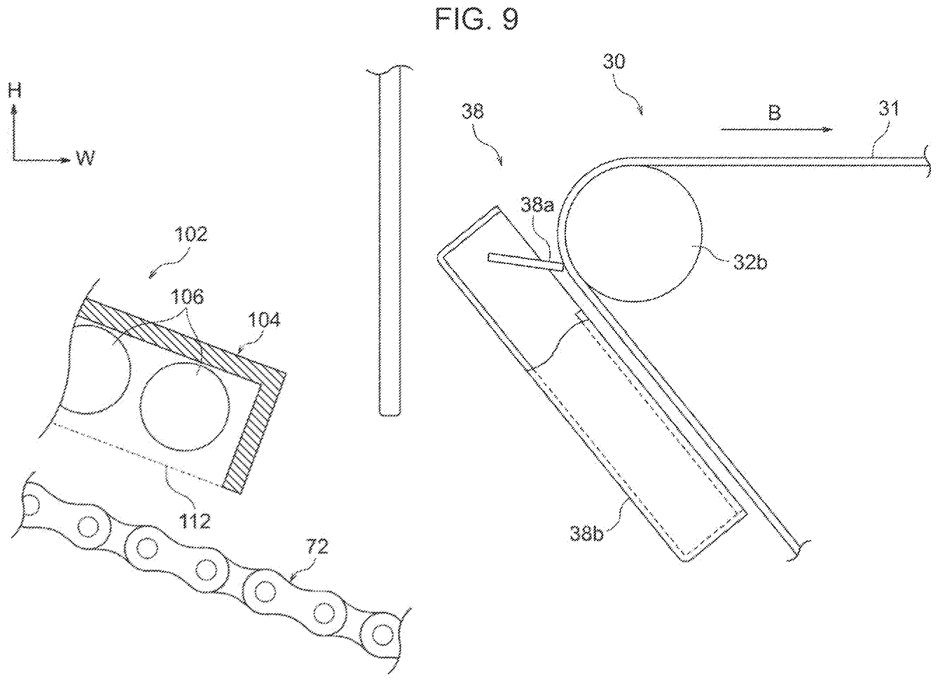

As illustrated in FIG. 9, the remover 38 includes a plate-like blade 38a that scrapes off adhering materials, such as toner, adhering to the transfer belt 31, and a collection box 38b that collects the adhering materials scraped off by the blade 38a. Thus, the remover 38 is designed to remove the adhering materials adhering to the transfer belt 31.

### Others

As illustrated in FIG. 2, the image forming apparatus 10 includes a division plate 98 as an example of a divider to divide the principal heater 120 and the pre heater 102, and the remover 38 in the device width direction as well as to reduce air flow from the area where the principal heater 120 and the pre heater 102 are disposed to the area where the remover 38 is disposed. In the present exemplary embodiment, the range to be divided by the division plate 98 in the device up-down direction is the entire range where the principal heater 120 and the pre heater 102 are disposed.

The range to be divided by the division plate 98 in the device up-down direction may be part of the range where the remover 38 overlaps with the range where the principal heater 120 and the pre heater 102 are disposed in a horizontal view. Furthermore, the range to be divided by the division plate 98 in the device up-down direction is desirably at least half of the range where the remover 38 overlaps with the range where the principal heater 120 and the pre heater 102 are disposed in a horizontal view. Particularly, the range to be divided by the division plate 98 in the device up-down direction is desirably the entire range where the remover 38 overlaps with the range where the principal heater 120 and the pre heater 102 are disposed in a horizontal view. In another viewpoint, the division plate 98 desirably extends to a point below the device lower end of the remover 38. The division plate 98 desirably blocks the heat of the principal heater 120 and the pre heater 102 from reaching not only the remover 38, but also the components of the image former 12, such as the toner image former 20Y. Particularly, in the present exemplary embodiment, the toner image former 20 is disposed above the remover 38, thus the upward end of the division plate 98 is desirably provided up to a position above the height of the toner image former 20 in the device up-down direction.

### Operation of Principal Component Configuration

Next, the operation of the image forming apparatus 10 and the fixing device 100 according to the present exemplary embodiment will be described in comparison with an image forming apparatus 310 and a fixing device 400 according to a comparative embodiment. First, for the configuration of the image forming apparatus 310 and the fixing device 400 according to a comparative embodiment, the point of difference from the configuration of the image forming apparatus 10 and the fixing device 100 according to the present exemplary embodiment will be described.

### Image Forming Apparatus 310, Fixing Device 400

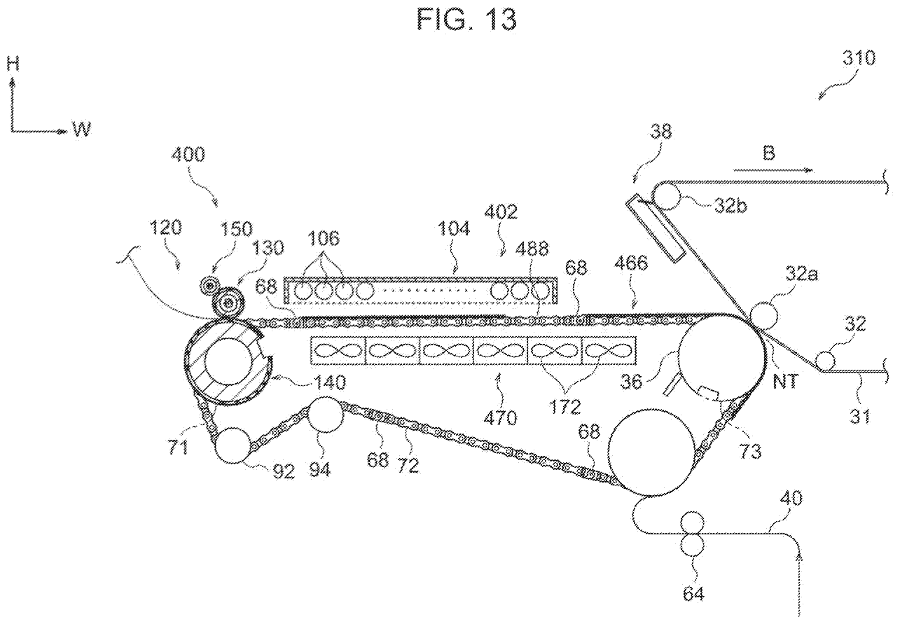

As illustrated in FIG. 13, the fixing device 400 of the image forming apparatus 310 includes a chain gripper 466, a pre heater 402, a principal heater 120, and a blowing unit 470. The image forming apparatus 310 does not include a division plate to divide the principal heater 120, the pre heater 402, and the remover 38 in the device width direction. In the image forming apparatus 310, the remover 38 is disposed on the upper side of the upper end of the pre heater 402.

In the fixing device 400, the chain gripper 466 differs from the chain gripper 66 in the angle of disposition, and includes the pair of chains 72, the leading edge holding unit 68, and the sprockets 71, 73, 92, 94, 96. In the fixing device 400, the pressure roll 140 is disposed so that the part of the chains 72 between the chain section wound over the sprocket 73 and the chain section wound over the sprocket 71 extends in the horizontal direction. That is, in the fixing device 400, a transport path 488 for the sheet member P from the second transfer position NT to the principal heater 120 extends in the horizontal direction.

The pre heater 402 includes the reflection member 104, multiple heaters 106, and the wire mesh 112. The pre heater 402 is disposed along the horizontally extending transport path 488 for the sheet member P.

The blowing unit 470 includes multiple fans 172 arranged side by side in the width direction of the transported sheet member P and in the sheet transport direction. The blowing unit 470 is disposed along the horizontally extending transport path 488 for the sheet member P so that the transported sheet member P passes between the blowing unit 470 and the pre heater 402.

### Operation of Image Forming Apparatus 10 and Fixing Device 100

In the image forming apparatus 10 of the present exemplary embodiment illustrated in FIG. 12, the toner image former 20 of each color included in the image former 12 forms a toner image of the color on the surface of the photoconductor drum 21 of the color. Furthermore, the first transfer roll 33 of the transfer device 30 transfers a toner image to the circumferentially rotating transfer belt 31, the toner image being formed on the surface of the photoconductor drum 21 of the color.

The delivery roll 62 delivers the sheet member P from the storage section 50 to the paper feed path 40, and the transport roll 64 transports the sheet member P delivered to the paper feed path 40 to the chain grippers 66, 466. The leading edge holding unit 68 of the chain grippers 66, 466 receives the sheet member P at the lower end position of the sprockets 96 illustrated in FIG. 1, FIG. 13, and holds the sheet member P by gripping the leading edge of the sheet member P.

The circumferentially rotating chains 72 transport the sheet member P, and causes it to pass through the second transfer position NT where the transfer belt 31 and the second transfer roll 36 come into contact with each other. Thus, a toner image on the transfer belt 31 is transferred to the surface of the sheet member P. In addition, the circumferentially rotating chains 72 transport the sheet member P with a transferred toner image so that the sheet member P is opposed to the pre heaters 102, 402. The circumferentially rotating chains 72 further transport the sheet member P opposed to the pre heaters 102, 402 to the principal heater 120.

Here, in the fixing device 400 according to the comparative embodiment, as illustrated in FIG. 13, the transport path 488 for the sheet member P from the second transfer position NT to the principal heater 120 extends in the horizontal direction. Thus, in the comparative embodiment, the pre heater 402 disposed along the transport path 488 extending in the horizontal direction heats the toner image on the sheet member P in a contactless manner in the thickness direction of the sheet member P transported by the circumferentially rotating chains 72. Heating the toner image on the sheet member P causes the toner in the toner image to be softened.

In the image forming apparatus 310 according to the comparative embodiment, the fans 172 of the blowing unit 470 blow air to the sheet member P from the opposite side of the pre heater 402 to stabilize the transport posture of the sheet member P so that the sheet member P is transported horizontally.

In contrast, in the image forming apparatus 10 of the present exemplary embodiment, as illustrated in FIG. 1, the transport path 88 for the sheet member P from the second transfer position NT to the principal heater 120 extends in an inclination direction inclined with respect to the horizontal direction. Thus, the pre heater 102 disposed along the transport path 88 extending in an inclination direction heats a toner image on the sheet member P transported by the circumferentially rotating chains 72 in a contactless manner in the thickness direction of the sheet member P. Heating the toner image on the sheet member P causes the toner in the toner image to be softened.

In the image forming apparatus 10, the fans 172 of the blowing unit 170 blows air to the sheet member P from the opposite side of the pre heater 102 to stabilize the transport posture of the sheet member P so that the sheet member P is transported in an inclination direction.

In the principal heater 120 illustrated in FIG. 1, FIG. 13, the heating roll 130 and the pressure roll 140 transport the sheet member P heated by the pre heaters 102, 402 by gripping the sheet member P, and a toner image is fixed on the sheet member P. After the sheet member P passes through the principal heater 120, the leading edge holding unit 68 releases edge holding of the sheet member P, and the chain gripper 66 delivers the sheet member P to the paper discharge path 42.

The cooler 90 illustrated in FIG. 12 cools the sheet member P delivered to the paper discharge path 42 while transporting the sheet member P. Furthermore, the transport roll 54 transports the sheet member P cooled by the cooler 90 along the paper discharge path 42, and discharges the sheet member P to the discharge section 52 outside the device body 10a.

### General Overview

As described above, in the fixing device 100 of the present exemplary embodiment, the pre heater 102 is disposed along the transport path 88 extending in an inclination direction inclined with respect to the horizontal direction (see FIG. 1). In contrast, in the fixing device 400 in the comparative embodiment, the pre heater 402 is disposed along the transport path 488 extending in the horizontal direction (see FIG. 13). Thus, as compared with the fixing device 400 in the comparative embodiment, the fixing device 100 of the present exemplary embodiment is configured to reduce increase in device size in the device width direction (horizontal direction).

In the fixing device 100, the leading edge holding unit 68 mounted on the circumferentially rotating pair of chains 72 holds the sheet member P by gripping the leading edge of the sheet member P. Circumferential rotation of the pair of chains 72 causes the sheet member P to be transported. Thus, as compared with when the sheet member P is adsorbed onto a band-shaped belt, and transported, the heat from the sheet member P heated by the pre heater 102 is not transmitted to the belt, thus decrease in the temperature of the sheet member P is reduced. In other words, the amount of heat generated in the pre heater 102 can be reduced.

In the fixing device 100, the transport path 88 from the second transfer position NT to the principal heater 120 is inclined with respect to the horizontal direction so that the downstream section in the sheet transport direction is on the upper side of the upstream section. Thus, as compared with when the transport path 88 is inclined so that the downstream section in the sheet transport direction is on the lower side of the upstream section in the sheet transport direction, change in the transport posture of the sheet member P held by the leading edge being gripped during transport. is reduced.

In the fixing device 100, the position where the sheet member P is heated by the principal heater 120 is on the upper side of the position where the sheet member P is heated by the pre heater 102. Thus, part of the heat generated due to heating of the sheet member P by the pre heater 102 moves upward and reaches the position where the sheet member P is heated by the principal heater 120. Thus, decrease of the temperature of a toner image heated by the principal heater 120 is reduced, as compared with when the position where the sheet member P is heated by the principal heater is on the lower side or at the same height as the position where the sheet member P is heated by the pre heater 102 in the device up-down direction.

As compared with when the fixing device 400 in the comparative embodiment is included, the image forming apparatus 10 including the fixing device 100 of the present exemplary embodiment is configured to reduce increase in device size in the device width direction (horizontal direction).

In addition, in the image forming apparatus 10, the pre heater 102 and the principal heater 120 included in the fixing device 100 are apart from the image former 12 in the device width direction (horizontal direction) as viewed in the device depth direction. Thus, as compared with when the pre heater 102 and the principal heater 120 overlap with the image former 12 in the device width direction, flow of the heat generated by the pre heater 102 and the principal heater 120 to the image former 12 is reduced, thus increase to a higher temperature of the image former 12 is inhibited. In other words, heat damage to the image former 12 is reduced.

In the image forming apparatus 10, the second transfer position NT where the toner image is transferred to the sheet member P by the second transfer roll 36 is on the lower side of the position where the sheet member P is heated by the pre heater 102. Thus, as compared with when the second transfer position NT is on the upper side of the position where the sheet member P is heated by the pre heater 102, flow of the heat generated by the pre heater 102 to the second transfer position NT is reduced.

In the image forming apparatus 10, the remover 38 that removes the adhering materials adhering to the transfer belt 31 is apart from the pre heater 102 in the device width direction (horizontal direction) as viewed in the device depth direction. Thus, as compared with when the pre heater 102 overlaps with the remover 38 in the device width direction, flow of the heat generated by the pre heater 102 to the remover 38 is reduced, thus increase to a higher temperature of the remover 38 is inhibited.

In the image forming apparatus 10, the remover 38 is disposed on the lower side of the upper end of the pre heater 102 in the up-down direction (vertical direction). As compared with when the remover 38 is disposed on the upper side of the upper end of the pre heater 102, flow of the heat generated by the pre heater 102 to the remover 38 is reduced, thus increase to a higher temperature of the remover 38 is inhibited. Since increase to a higher temperature of the remover 38 is inhibited, in the adhering materials scraped and collected in the collection box 38b by the blade 38a of the remover 38, adherence of toner inside the collection box 38b is inhibited.

Although a specific exemplary embodiment of the present disclosure has been described in detail, the present disclosure is not limited to the exemplary embodiment, and it is apparent for those skilled in the art that various other exemplary embodiments are possible in the scope of the present disclosure. For example, in the exemplary embodiment, the sheet member P is transported along the transport path 88 extending in an inclination direction by circumferentially rotating the pair of chains 72. The sheet member P may be transported along the transport path 88 extending in an inclination direction, and, for example, the sheet member P may be transported using multiple rolls.

In the exemplary embodiment, the sheet member P is transported by holding the leading edge of the sheet member P; however, the sheet member P may be transported by holding the both ends of the sheet member P, for example. In this case, the effect achieved by transporting the sheet member P by holding the leading edge thereof is not achieved.

In the exemplary embodiment, the transport path 88 is inclined so that the downstream section in the sheet transport direction is on the upper side of the upstream section; however, the transport path 88 may be inclined so that the downstream section in the sheet transport direction is on the lower side of the upstream section. In this case, the effect achieved by inclining the transport path 88 so that the downstream section in the sheet transport direction is on the upper side of the upstream section is not achieved.

In the exemplary embodiment, the position where the sheet member P is heated by the principal heater 120 is on the upper side of the position where the sheet member P is heated by the pre heater 102. However, the position where the sheet member P is heated by the principal heater may be on the lower side of the position where the sheet member P is heated by the pre heater. In this case, the effect achieved by placing the position where the sheet member P is heated by the principal heater 120 on the upper side of the position where the sheet member P is heated by the pre heater 102 is not achieved.

In the exemplary embodiment, a description has been given using the chains 72 as a pair of circumferential rotation units; however, as long as circumferential rotation is made, a belt may be used, for example.

In the exemplary embodiment, the pair of chains 72 circumferentially rotate; however, it is sufficient that the sheet member P be opposed to the pre heater 102 after being transported, and the pair of chains 72 may not circumferentially rotate.

In the exemplary embodiment, the principal heater 120 is disposed at the end of the transport path 88; however, the principal heater 120 may be disposed in the middle of the transport path 88.

Although various exemplary embodiments have been described with reference to the drawings in the above, the present disclosure is not limited to those examples. It is apparent that various modifications and alterations will occur to those skilled in the art within the scope of the appended claims, and it should be understood that those modifications and alterations naturally fall within the technical scope of the present disclosure. In a range without departing from the spirit of the present disclosure, the components in the above exemplary embodiments may be combined in any manner.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. A fixing device comprising:
a heater that heats an image transferred to a recording medium transported, in a contactless manner;
a holding unit that holds the recording medium; and
a transport unit that transports the recording medium held by the holding unit along a transport path for the recording medium so that the recording medium is opposed to the heater,
wherein the transport path extends in an inclination direction inclined with respect to a horizontal direction as viewed in a width direction of the recording medium transported, and the heater is disposed along the transport path,
wherein the transport unit transports the recording medium along the transport path which is inclined so that a downstream section is on an upper side of an upstream section in a transport direction of the recording medium,
wherein the fixing device further comprises a contact heater that is disposed downstream of the heater in the transport direction of the recording medium, and comes into contact with the recording medium to heat an image,
wherein in a vertical direction, a position where an image on the recording medium is heated by the contact heater is on an upper side of a position where the image on the recording medium is heated by the heater, and
wherein the contact heater includes a heating roll and a driven roll, the driven roll being disposed to extend in an axial direction on an opposite side of the heating roll from the recording medium, the driven roll including a built-in heater and configured to heat the heating roll.

2. The fixing device according to claim 1,
wherein the holding unit includes a leading edge holding unit that extends in the width direction of the recording medium transported, and holds the recording medium by gripping a leading edge of the recording medium, and
the transport unit includes a circumferential rotation unit on which an end of the leading edge holding unit is mounted, and which circumferentially rotates to transport the recording medium.

3.-6. (canceled)

7. An image forming apparatus comprising:
the fixing device according to claim 1, that fixes the image transferred to a recording medium on the recording medium; and
an image former that is apart from the heater included in the fixing device in a horizontal direction as viewed in a width direction of the recording medium transported, and forms an image and transfers the image to the recording medium.

8. An image forming apparatus comprising:
the fixing device according to claim 2, that fixes the image transferred to a recording medium on the recording medium; and
an image former that is apart from the heater included in the fixing device in a horizontal direction as viewed in a width direction of the recording medium transported, and forms an image and transfers the image to the recording medium.

9.-12. (canceled)

13. The image forming apparatus according to claim 7,
wherein in a vertical direction, a transfer position where the image former transfers an image to the recording medium is on a lower side of a position where the image on the recording medium is heated by the heater.

14. The image forming apparatus according to claim 8,
wherein in a vertical direction, a transfer position where the image former transfers an image to the recording medium is on a lower side of a position where the image on the recording medium is heated by the heater.

15.-17. (canceled)

18. An image forming apparatus comprising:
a toner image former that forms a toner image as an image;
an endless-formed transfer belt that receives transfer of the toner image formed by the toner image former while circumferentially rotating;
a transfer unit that transfers to a recording medium the toner image transferred to the transfer belt;
the fixing device according to claim 1, that fixes the toner image transferred to the recording medium by the transfer unit on the recording medium; and
a remover that removes an adhering material adhering to the transfer belt, and is apart from the heater included in the fixing device in a horizontal direction as viewed in a width direction of the recording medium transported.

19. The image forming apparatus according to claim 18,
wherein the remover is disposed on a lower side of an upper end of the heater in a vertical direction.

20. The image forming apparatus according to claim 19, further comprising:
a divider in space between the heater and the remover which are apart in a horizontal direction.
